(19) United States
(12) Patent Application Publication
(10) Pub. No.: US 2022/0336892 A1
(43) Pub. Date: Oct. 20, 2022

(54) HEAT EXCHANGER AND HEAT EXCHANGER ARRANGEMENT COMPRISING A PLURALITY OF HEAT EXCHANGERS

(71) Applicant: Hanon Systems, Daejeon (KR)

(72) Inventors: David Rochholz, Köln (DE); Peter Friesen, Niederzier (DE); Florian Bieregger, München (DE)

(21) Appl. No.: 17/753,412

(22) PCT Filed: Nov. 23, 2020
(86) PCT No.: PCT/KR2020/016568

§ 371 Date: Mar. 2, 2022

(30) Foreign Application Priority Data
Dec. 20, 2019 (DE) 10 2019 220 406.6

(51) Int. Cl. H01M 10/6569; F28D 21/00; H01M 10/613; H01M 10/625; H01M 10/6554; H01M 10/6556

(52) U.S. Cl. CPC H01M 10/6569; F28D 21/00; H01M 10/613; H01M 10/625; H01M 10/6554; H01M 10/6556; F28D 2021/0028

(57) ABSTRACT

A heat exchanger includes at least one plate, which heat exchanger or plate can be mounted on a battery module of an electric vehicle, and a plurality of at least partially parallel channels for the evaporation of refrigerant are formed in a plane parallel to the plate and are branched from at least one common inlet and/or outlet.

### CROSS-REFERENCE TO RELATED PATENT APPLICATIONS

This patent application is a United States national phase patent application based on PCT/KR2020/016568 filed on Nov. 23, 2020, which claims the benefit of German Patent Application No. 10 2019 220406.6 filed on Dec. 20, 2019, the entire disclosures of which are hereby incorporated herein by reference.

### TECHNICAL FIELD

The invention relates to a heat exchanger comprising at least one plate, which heat exchanger or plate can be mounted on a battery module of an electric vehicle, which is the object to be cooled, and to a heat exchanger arrangement comprising a plurality of heat exchangers.

### BACKGROUND ART

Electric and hybrid vehicles have become more and more popular in recent years so as to reduce fossil fuel consumption. However, the accumulators of these types of vehicles must be cooled in certain operating situations. While doing so, the temperature differences between individual cells of the accumulator must be kept as low as possible. The loss of pressure within a cooler or a heat exchanger intended for this purpose should also be kept as low as possible. It is at the same time necessary to keep an eye on the overall stability of the heat exchanger.

Indentations or “dimples” are used as flow guiding and distributing elements in heat exchangers for refrigerants and coolants in order to optimize flow guidance. At the same time, this increases turbulences, which leads to an increase in the heat transfer coefficient from the fluid to a solid, for example a plate of the heat exchanger or a housing of the accumulator. As regards a heat exchanger for refrigerants, it must additionally be noted that heat absorption is particularly efficient when refrigerant evaporates, but there is no need to generate turbulences. However, with such an approach, the heat exchanger is still to be optimized with respect to heat transfer and packing density.

U.S. Pat. No. 9,134,072 B relates to a heat exchanger that is provided for two fluids and in which the flow channels are branched multiple times and intermingle.

### SUMMARY

Against this background, the invention is based on the object of creating an optimized heat exchanger for heat transfer between a fluid and a solid body.

The solution of this object is achieved by the heat exchanger as shown and disclosed herein.

According thereto, the heat exchanger comprises at least one plate that can typically be mounted on an object to be cooled, such as an accumulator or a battery. Although reference is sometimes made in the following to an object to be cooled, an accumulator or a battery in general, the heat exchanger according to the invention is particularly configured for the intended use as a battery cooler and as a contact evaporator for refrigerants, and in this respect can be mounted in its entirety, and preferably by means of the plate thereof, on a battery module of an electric vehicle.

A plurality of at least partially parallel channels for the evaporation of refrigerant are formed here in a plane parallel to the plate and are branched from at least one common inlet and/or outlet. The formation parallel to the plate essentially means that at least one boundary, which is apparent in a cross-sectional view of the channel, is formed parallel to the surface of the plate and typically coincides therewith. The opposite boundary, and thus the “height” of the channels over the plate plane, can also lie in the same plane for all channels. However, this is not necessarily required.

The channels typically become narrower downstream of any branchings (in a direction parallel to the plate plane) such that a constant flow rate can be maintained. The reverse applies downstream of any junctions of channels (i.e. the channels become wider). The structure comprising a plurality of branchings can be described as meandering, tree-like, or vein-like. The invention is thus based on the basic principles of bionics. The narrowing or widening applies to the channels in the flow direction before and after branchings or junctions. The channels as such preferably have a constant cross-sectional surface over the course thereof.

Furthermore, the channels can be configured by means of simple measures such that they withstand the necessary pressures and there is overall a lower loss of pressure. The heat exchanger according to the invention is in particular configured for evaporation of the refrigerant that can correspond to a refrigerant used in vehicle air conditioning systems. By forming the heat exchanger with a plate, said exchanger can be built in different sizes and/or modularly, and can be easily adapted to various arrangements of accumulators and requirements as regards the cooling capacity, acceptable pressure losses, etc. Furthermore, a high packing density at low weight is realized with the heat exchanger according to the invention. Ultimately, a further advantage of the channel structure according to the invention is the higher degree of safety during the soldering process used for manufacturing the plate.

Although it is possible in specific cases of use that each channel is only branched once, it is advantageous for possible uses of the heat exchanger according to the invention if at least one channel, which itself starts at a branching, is branched again.

In initial simulations, providing at least one branching with more than two channels, in particular three or four channels, has furthermore proven to be advantageous.

It has furthermore proven to be advantageous, in particular in such a case, to provide at least one flow guiding element in at least one branching in order to improve the fluid flow in the direction of the channels starting from the branching.

It is preferred that such a flow guiding element extends over the entire internal height of the flow channel to be branched. In other words, the flow channel is blocked across its entire height over the plate surface such that the refrigerant meeting such a flow guiding element is directed in a particularly reliable manner in the direction of the flow channels located downstream of the branching. This is supported by the turbulences generated by the flow guiding element. In addition, such an interruption of the flow channel, or in other words a connection between the plate plane and the boundary of the flow channels in a plane spaced apart from the plate plane, supports the stability of the entire heat exchanger such that it can withstand occurring stresses even at a pressure of the refrigerant of up to 20 bar. This effect is based on the fact that a surface in the region of a branching, in particular a branching into more than two channels, can be reduced and stabilized.

In initial simulations, a flow guiding element has furthermore proven to be advantageous that is formed so as to be essentially round, when viewed in a direction perpendicular to the plate plane.

As has already been stated, it is advantageous with regard to design and manufacturability if all channels have the same internal height over the plate plane, in other words if the boundary that is spaced apart from the plate plane lies in a common plane in a cross-sectional view. In combination therewith, the already mentioned measure is preferred that the channels differ in the width thereof transverse to the plate plane.

In the case of two or more inlets and/or outlets, it is currently also preferred that the channels connected to a common inlet or outlet are at least partially symmetrical to other channels connected to another inlet or outlet. This ensures a particularly neat and efficient arrangement of the channels.

As regards the durability of the heat exchanger according to the invention, it is advantageous if the plate withstands a pressure of at least 20 bar, preferably at least 60 bar. This is the bursting pressure of the plate and it defines the safety margin from normal operation to bursting (failure).

It is furthermore advantageous if at least two channels, preferably a plurality thereof, are locally connected to each other in the course thereof between inlet and outlet in order to create a bypass and to enable mixing between the individual channels. The connection of at least two parallel channels can be achieved by means of a suitable transverse stamping or beading. A mixing of the fluid flows of at least two channels is advantageous in that the refrigerant in individual channels can have different temperatures and/or states of aggregation. In this respect, mixing ensures homogenization and improved cooling, for example of a battery.

The same effect, i.e. improvement of the thermal management of a battery or an accumulator, can be achieved by arranging the inlet and outlet in such a manner that channels lying next to each other are flowed through in counterflow. In other words, at least one channel comprising refrigerant that is already overheated is located next to a channel with evaporating refrigerant such that heat transfer also occurs between two channels arranged in this manner.

The subject matter of the application is furthermore a heat exchanger arrangement comprising a plurality of heat exchangers in one of the embodiments described above, which are connected to each other in parallel and/or in series and/or lie in a common plane or in parallel planes.

### BRIEF DESCRIPTION OF DRAWINGS

Preferred embodiment examples of the invention are explained in more detail below, with reference to the figures, wherein:

FIG. 1 is a top view of a heat exchanger according to the invention;

FIG. 2 is a top view of a section of a heat exchanger that is similar to the one shown in FIG. 1;

FIG. 3 is a top view of a second embodiment of the heat exchanger according to the invention; and

FIG. 4 is a heat exchanger arrangement according to the invention.

### DETAILED DESCRIPTION OF AN EMBODIMENT

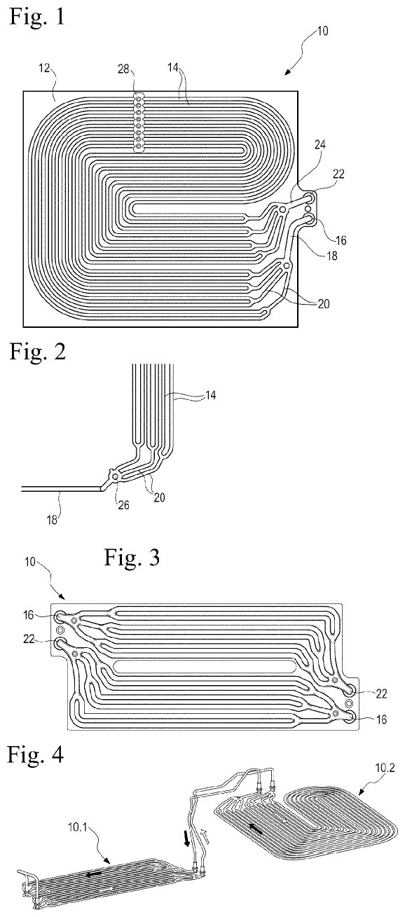

FIG. 1 shows a top view of the heat exchanger 10 according to the invention on the plate 12 thereof, on which numerous channels 14 run largely parallel to each other. They start from a common inlet 16 to which an inlet channel 18 is connected. In the shown embodiment, said channel branches into four intermediate channels 20, and each one of these intermediate channels 20 branches into two channels 14 which are not further branched, but run largely parallel to each other over the entire plate, including in the region of bends of 90° or even 180°, for example, before they merge upstream of an outlet 22 in a manner essentially corresponding to the situation at the inlet 16. In the shown embodiment, two channels 14 respectively merge to form an intermediate channel 20, and four intermediate channels 20 merge to form the outlet channel 24 leading to the outlet 22.

As is apparent from the drawing in FIG. 1, the entire surface of the plate can essentially be covered by the numerous channels 14 such that no significant temperature differences are to be expected for a plurality of battery cells or accumulator cells arranged next to each other in such a manner that the plate 12 can be mounted on a plurality of such cells.

In the shown embodiment, the inlet 16 and outlet 22 are located comparatively close to each other and are in particular located approximately in the middle of one side of the plate. A preferred measure is furthermore shown, according to which the individual channels 14 are largely symmetrical to each other with respect to an axis of symmetry running transversely over the plate, i.e. from left to right in FIG. 1. Moreover, the preferred measure according to which a plurality of, in the shown case all, parallel channels are connected to each other in order to enable mixing of the fluid flows is shown in FIG. 1 in the form of the connection 28. Ultimately, it is particularly apparent from FIG. 1 that channels lying next to each other are flowed through in counterflow. Using the spaces available on the shown plate 12, the refrigerant flows in the shown case from the bottom right to the top right in the parallel channels on the outside of the plate, and, following the bend of 180° in the upper right region according to FIG. 1, it flows back in the inner region of the plate, thus resulting in the above-described counterflow and the specified advantages. It should be noted that this similarly applies to the embodiment of FIG. 3, albeit to a lesser extent. It should furthermore be mentioned that the heat exchanger of FIG. 1 could also be flowed through in the opposite direction, i.e. first in the inner region and then in the outer region. This would have the advantage that there would be a comparatively cold refrigerant in the inner region and thus in the comparatively hot region of a battery to be cooled.

FIG. 2 shows the region with the branchings between the inlet channel 18 and the individual channels 14, which corresponds in this case to the situation at the outlet 22 but could also be provided with this configuration in the region of the inlet 16. In particular in the region of the inlet, a flow guiding element 26 is of importance, which is located at the branching of the inlet channel 18 into the three intermediate channels 20, and which ensures a favorable distribution among said intermediate channels 20. In the shown case, the flow guiding element 26 is formed so as to be essentially round in the top view and interrupts the flow channel in its entirety. In other words, the upper boundary (facing the observer) of the flow channels is connected to the plate 12 (facing away from the observer; cf. FIG. 1) such that a “dimple” blocking the flow is formed. In the shown case, said flow guiding element is provided between the second and the third intermediate channel 20 such that, as mentioned above, a favorable distribution among all three intermediate channels 20 takes place.

FIG. 3 shows an alternative embodiment of the heat exchanger 10 according to the invention, in which two inlets 16 and two outlets 22 are provided. In this embodiment, the flow channels starting from the inlet 16 merge towards the edge (i.e. the right edge according to FIG. 3) of the plate 12, where they are re-united. From there, there can either be a connection to the backflow channels apparent at the bottom of FIG. 3, the inlet 16 of which is accordingly at the bottom on the far right in FIG. 3. Alternatively, the shown heat exchanger can be connected by means of the outlet 22 thereof to further heat exchangers of an arrangement that will be described in more detail below. Two of the heat exchangers shown in FIG. 3 can essentially be provided symmetrically to a transverse axis of symmetry. Furthermore, the number of backflow channels can be higher (eight, for example) than the number of inflow channels (six, for example), in particular in a heat exchanger that lies directly at the inlet and outlet of an entire heat exchanger arrangement.

This is apparent from FIG. 4, for example, in which the heat exchanger of FIG. 3 is provided as the left, first heat exchanger 10.1. As is apparent from FIG. 4, the heat exchanger 10.1 is connected to a further heat exchanger 10.2 which can be configured as according to FIG. 1 such that the refrigerant first flows through the heat exchanger 10.1, then through the heat exchanger 10.2, and then flows back therefrom to the outlet 22 through the heat exchanger 10.1. A plurality of accumulators arranged in a dispersed manner can be cooled by the arrangement shown in FIG. 4. Ultimately, a plurality of arrangements according to or similar to FIG. 4 can be provided, for example with a mirror-inverted heat exchanger according to 10.1, a further heat exchanger that is parallel below or above 10.2, or with the arrangement of FIG. 4 mirror-inverted once again.

1-12. (canceled)

13. A heat exchanger comprising:
at least one plate, which heat exchanger or plate can be mounted on a battery module of an electric vehicle, wherein a plurality of at least partially parallel channels for the evaporation of refrigerant are formed in a plane parallel to the at least one plate and are branched from at least one common inlet and/or outlet.

14. The heat exchanger according to claim 13, wherein at least one intermediate channel, which starts at a branching, is branched again.

15. The heat exchanger according to claim 14, wherein more than two intermediate channels start at at least one branching.

16. The heat exchanger according to claim 13, wherein at least one flow guiding element is provided in at least one branching.

17. The heat exchanger according to claim 16, wherein the at least one flow guiding element is formed over an entire internal height of a channel.

18. The heat exchanger according to claim 16, wherein the at least one flow guiding element is formed so as to be essentially round in a top view of the plane of the at least one plate.

19. The heat exchanger according to claim 13, wherein all of the plurality of channels have a same internal height.

20. The heat exchanger according to claim 13, wherein there are two or more inlets and/or outlets, ones of the plurality of channels connected to a same one of the inlets or outlets are at least partially symmetrical to other ones of the plurality of channels connected to another one of the inlets or outlets.

21. The heat exchanger according to claim 13, wherein the at least one plate can withstand a pressure of at least 20 bar.

22. The heat exchanger according to claim 13, wherein at least two of the plurality of channels are locally connected to each other.

23. The heat exchanger according to claim 13, wherein the inlet and the outlet are arranged in such a manner that the plurality of channels arranged next to each other are flowed through in counterflow.

24. A heat exchanger arrangement comprising a plurality of heat exchangers according to claim 13.
